(19) United States
(12) Patent Application Publication
(10) Pub. No.: US 2026/0051048 A1
(43) Pub. Date: Feb. 19, 2026

(54) STYLE TRANSFER OF SURGERY VIDEOS FOR CUSTOM VISUALIZATION

(71) Applicant: Stryker Corporation, Portage, MI (US)

(72) Inventors: Bhavya Nishitkumar AJANI, Bengaluru (IN); Kaleeswaran MURUGAN, Bengaluru (IN); Swathi, Thrissur (IN); Naveenkumar RANGASAMY, Bengaluru (IN)

(73) Assignee: Stryker Corporation, Portage, MI (US)

(21) Appl. No.: 19/003,946

(22) Filed: Dec. 27, 2024

Related U.S. Application Data
(60) Provisional application No. 63/615,750, filed on Dec. 28, 2023.

(51) Int. Cl. G06T 7/00

(52) U.S. Cl. CPC G06T 7/0012; G06T 2207/10016; G06T 2207/20081; G06T 2207/20132

(57) ABSTRACT

Disclosed herein are systems and methods configured to modify a style of a video stream or one or more images of a target area of a subject. The style of the video stream or image(s) may be modified according to user input, e.g., a selection of a reference style indicative of a surgeon's preferences for visualizing the target area of the subject, such as during or after a procedure. The reference style may be a fixed reference style stored in memory, or a matched reference style. The video stream and/or image(s) may be captured using a video camera. The system may generate a modified video stream and/or modified image(s) of the target area of the subject to be displayed. The modified video stream or image(s) may include the content of the original video stream or image(s) captured by a camera (e.g., laparoscopic camera) and the style of the surgeon's preferences.

### CROSS-REFERENCE TO RELATED APPLICATIONS

This application claims the benefit of U.S. Provisional Application No. 63/615,750, filed on Dec. 28, 2023, which is hereby incorporated by reference in its entirety.

### FIELD

The present invention relates to medical imaging, and more specifically, style transfer in surgery videos, such as laparoscopic videos, for custom visualization.

### BACKGROUND

Medical imaging systems (e.g., laparoscopic imaging systems or endoscopic imaging systems for minimally invasive surgery) can help provide clinical information for medical practitioners who need to make decisions (e.g., intraoperative or treatment decisions) based on visualization of tissue. The medical imaging system may involve guiding a camera to the treatment area and using a display system for displaying the entire procedure in real time to the medical practitioner. There are different cameras and display systems available for use in the procedure, but each one may have its own style, making the captured video appear different when displayed on the display system. For example, there may be variations in luma and chroma with different cameras and different display systems. These variations may lead to some systems showing, e.g., anatomical structures with more redness. In some instances, the redness level may increase during intraoperative events like bleeding, which may interfere with the surgeon's workflow and decision making. These events may cause difficulty in identifying different anatomical structures clearly.

There may be a lot of features and differences in colors depending on the device and other equipment used. Due to variations in device configurations, the device itself, or other external factors (e.g., room lighting conditions), the style or appearance of images captured during a medical procedure may not be consistent. Surgeons may become accustomed to visualizing the surgical field in one particular type of style, which may limit the surgeon to moving or upgrading to a different system.

### SUMMARY

Disclosed herein are systems and methods for modifying a style of a video stream or one or more images of a target area of a subject. A surgeon may prefer to visualize the target area with a particular type of style. The systems and methods may receive a video stream captured by a camera during a procedure, and may determine the content of the video stream. The style may be determined from the surgeon's preferred style, and a modified video stream or image(s) may be generated by a model using the determined content and the determined style. In some aspects, the model may convert the style of the video stream or image(s) in real time. In this manner, the surgeon may be able to visualize the target area according to his or her style preferences, while retaining the content of the video stream or image(s).

A computer-implemented method for modifying a style of one or more images of a target area of a subject is disclosed. The computer-implemented method comprises: receiving the one or more images of the target area of the subject; determining a content of the one or more images of the target area of the subject; receiving an input from a user; determining a reference style based on the user input; and generating one or more modified images of the target area of the subject using the determined content and the determined reference style. Additionally or alternatively, in some examples, the receiving, the determining, and the generating steps are performed in real time. Additionally or alternatively, in some examples, the receiving, the determining, and the generating steps are performed post-operatively. Additionally or alternatively, in some examples, wherein the determining the content comprises generating a content embedding from the one or more images. Additionally or alternatively, in some examples, the determining the reference style comprises selecting the reference style from a plurality of reference styles stored in memory. Additionally or alternatively, in some examples, selected reference style is selected based on the user input. Additionally or alternatively, in some examples, the plurality of reference styles are pre-determined reference styles. Additionally or alternatively, in some examples, the determining the reference style comprises generating a style embedding from one or more reference images. Additionally or alternatively, in some examples, the determining the reference style comprises matching a style of the one or more images to the reference style of one or more reference images. Additionally or alternatively, in some examples, the computer-implemented method further comprises: selecting a model from a plurality of models stored in memory, wherein the model performs the determining and the generating steps. Additionally or alternatively, in some examples, the plurality of models are pre-trained models. Additionally or alternatively, in some examples, the selected model is based on the user input. Additionally or alternatively, in some examples, the selected model is based on the determined reference style. Additionally or alternatively, in some examples, the computer-implemented method further comprises: training a model to perform the determining steps in real time, wherein the training the model is performed before the receiving step. Additionally or alternatively, in some examples, the one or more modified images comprise a style-normalized image. Additionally or alternatively, in some examples, the determining the reference style comprises using a dimensional vector that represents style information of the one or more images, the style information include one or more of: gamma, contrast, hue, saturation, brightness, color correction, or a combination thereof. Additionally or alternatively, in some examples, the generating the one or more modified images comprises selectively applying the determined reference style to the one or more images. Additionally or alternatively, in some examples, the generating the one or more modified images comprises applying white balancing. Additionally or alternatively, in some examples, the computer-implemented method further comprises: identifying an object of interest in the one or more images; and generating one or more masked images by masking areas in the one or more images outside of the identified object of the interest. Additionally or alternatively, in some examples, the computer-implemented method further comprises: switching from a first reference style to a second reference style during a procedure. Additionally or alternatively, in some examples, the computer-implemented method further comprises: selectively applying a first reference style to a first area of the one or more images; and selectively applying a second reference style to a second area of the one or more images. Additionally or alternatively, in some examples, the computer-implemented method further comprises: receiving a video stream of the target area of the subject, wherein the receiving the one or more images of the target area of the subject comprises extracting the one or more images from the video stream. Additionally or alternatively, in some examples, the receiving the one or more images comprises pre-processing the one or more images. Additionally or alternatively, in some examples, the content and the reference style are determined using one or more of: a single dimension neural network, a multidimension neural network, a generative adversarial network (GAN) model, or a combination thereof. Additionally or alternatively, in some examples, the content and the reference style are determined using a model trained using one or more unlabeled training images. Additionally or alternatively, in some examples, the content and the reference style are determined using a model tested using one or more test images having a correct style. Additionally or alternatively, in some examples, the content and style and determined using a model tested using one or more test images having a correct style and one or more test images having an incorrect style

A system for modifying a style of one or more images of a target area of a subject is disclosed. The system comprises: a camera configured to capture the one or more images or a video stream of the one or more images of the target area of the subject; a processing unit configured to receive an input from a user, the processing unit comprising: a model configured to: determine a content of the one or more images of the target area of the subject; determine a reference style based on the user input; and generate one or more modified images of the target area of the subject using the determined content and the determined reference style; and a display configured to display the one or more modified images or a modified video stream of the one or more modified images. Additionally or alternatively, in some examples, the receiving, the determining, and the generating steps are performed in real time. Additionally or alternatively, in some examples, the receiving, the determining, and the generating steps are performed post-operatively. Additionally or alternatively, in some examples, the model configured to determine the content comprises the model configured to generate a content embedding from the one or more images. Additionally or alternatively, in some examples, the processing unit comprises a memory, wherein the model configured to determine the reference style comprises the model configured to select the reference style from a plurality of reference styles stored in the memory. Additionally or alternatively, in some examples, the selected reference style is selected based on the user input. Additionally or alternatively, in some examples, the plurality of reference styles are pre-determined reference styles. Additionally or alternatively, in some examples, the model configured to determine the reference style comprises the model configured to generate a style embedding from one or more reference images. Additionally or alternatively, in some examples, the model configured to determine the reference style comprises the model configured to match a style of the one or more images to the reference style of one or more reference images. Additionally or alternatively, in some examples, the processing unit comprises a memory, the processing unit is configured to select the model from a plurality of models stored in the memory. Additionally or alternatively, in some examples, the plurality of models are pre-trained models. Additionally or alternatively, in some examples, the selected model is based on the user input. Additionally or alternatively, in some examples, the processing unit is configured to train the model to perform the determining steps in real time, wherein the training the model is performed before the receiving step. Additionally or alternatively, in some examples, the one or more modified images comprise a style-normalized image. Additionally or alternatively, in some examples, wherein the model configured to determine the reference style comprises the model using a dimensional vector that represents style information of the one or more images, the style information including one or more of: gamma, contrast, hue, saturation, brightness, color correction, or a combination thereof. Additionally or alternatively, in some examples, the model configured to generate the one or more modified images comprises the model configured to selectively apply the determined reference style to the one or more images. Additionally or alternatively, in some examples, the model configured to generate the one or more modified images comprises the model configured to apply white balancing. Additionally or alternatively, in some examples, the model is configured to: identify an object of interest in the one or more images; and generate one or more masked images by masking areas in the one or more images outside of the identified object of the interest. Additionally or alternatively, in some examples, the model is configured to: switch from a first reference style to a second reference style during a procedure. Additionally or alternatively, in some examples, the model is configured to: selectively apply a first reference style to a first area of the one or more images; and selectively apply a second reference style to a second area of the one or more images. Additionally or alternatively, in some examples, the model comprises one or more of: a single dimension neural network, a multidimension neural network, a generative adversarial network (GAN) model, or a combination thereof. Additionally or alternatively, in some examples, the model is trained using one or more unlabeled training images. Additionally or alternatively, in some examples, the model is tested using one or more test images having a correct style. Additionally or alternatively, in some examples, the model is tested using one or more test images having a correct style and one or more test images having an incorrect style.

A non-transitory computer-readable medium comprising instructions that, when executed by at least one processor, cause the at least one processor to execute operations modifying a style of one or more images of a target area of a subject is disclosed. The operations comprises: receiving the one or more images of the target area of the subject; determining a content of the one or more images of the target area of the subject; receiving an input from a user; determining a reference style based on the user input; and generating one or more modified images of the target area of the subject using the determined content and the determined reference style.

It will be appreciated that any of the variations, aspects, features, and options described in view of the systems apply equally to the methods and vice versa. It will also be clear that any one of the above variations, aspects, features, and options can be combined.

### BRIEF DESCRIPTION OF THE FIGURES

The invention will now be described, by way of example only, with reference to the accompanying drawings, in which:

FIG. 1 illustrates an example workflow for a medical imaging system, according to some aspects.

FIG. 2 illustrates an example high-level training workflow for a model that converts the style of an image in accordance with a selected reference style, according to some aspects.

FIG. 3 illustrates an example workflow for a fixed reference style, according to some aspects.

FIG. 4 illustrates an exemplary method for generating a modified image using a fixed reference style, according to some aspects.

FIG. 5A illustrates an example image, according to some aspects.

FIG. 5B illustrates an example modified image, according to some aspects.

FIG. 6 illustrates an example workflow for a matched reference style, according to some aspects.

FIG. 7 illustrates an exemplary method for generating a modified image using a matched reference style, according to some examples.

FIG. 8 illustrates an exemplary workflow for selectively applying a reference style to an object in an image, according to some aspects.

FIG. 9 illustrates an exemplary workflow for training and testing a model, according to some examples.

FIG. 10 illustrates an exemplary workflow for model inference, according to some examples.

FIG. 11 illustrates an example computing system, in accordance with some examples, that can be used for performing any of the methods described herein

### DETAILED DESCRIPTION

Reference will now be made in detail to implementations and various aspects and variations of systems and methods described herein. Although several example variations of the systems and methods are described herein, other variations of the systems and methods may include aspects of the systems and methods described herein combined in any suitable manner having combinations of all or some of the aspects described.

Systems and methods according to the principles described herein modify a style of a video stream or one or more images of a target area of a subject. The style of the video stream or image(s) may be modified according to a surgeon's preferences for visualizing the target area of the subject, such as during or after a procedure. The modified video stream or image(s) may include the content of the original video stream or image(s) captured by a camera (e.g., laparoscopic camera) and the style of the surgeon's preferences.

In the following description, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating,” or the like, refer to the action and processes of a computer system, or similar electronic computing device, that manipulates and transforms data represented as physical (electronic) quantities within the computer system memories or registers or other such information storage, transmission, or display devices.

The present disclosure in some examples also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability. Suitable processors include central processing units (CPUs), graphical processing units (GPUs), field-programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein.

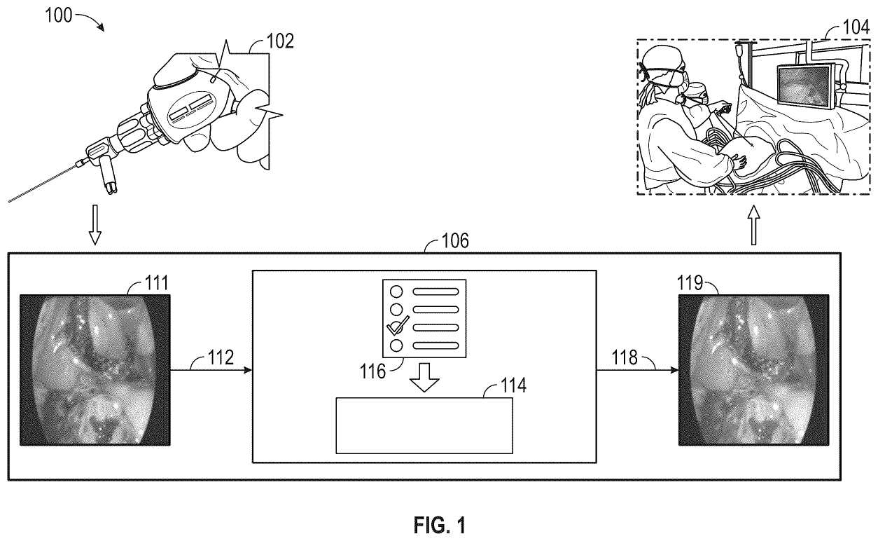

FIG. 1 illustrates an example workflow for a medical imaging system, according to some aspects. The medical imaging system 100 includes a camera head 102 and a display 104. The camera head 102 may comprise a laparoscopic camera comprising an elongated shaft with a distal end configured for insertion within a body cavity, for example. The shaft also comprises a proximal end for mounting a viewing port that allows the user to view the surgical field.

The camera head 102 may include at least one image sensor for acquiring one or more images (including one or more images that form video frames) that depict the target area. The image sensor may be a rolling shutter imager (e.g., CMOS sensors having an array of pixels arranged in rows of pixels and columns of pixels) or a global shutter imager (e.g., CCD sensors). In some aspects, the imager may include a mechanical shutter to control exposure of the image sensor and/or to control an amount of light received at the image sensor. The target area may include an object to be visualized (e.g., tissue).

The camera head 102 may be coupled to a light source (e.g., via a light guide such as a fiber optic cable) to selectively transmit light to a target area. The light source may illuminate the target area with illumination light (e.g., light in the visible light spectrum such as any combination of red, green, and blue light) for generating visible (e.g., white light) images of the target area and/or excitation light for generating fluorescent images of the target area. The illumination light may be transmitted to and through an optic lens system that focuses light on the target area. The camera head 102 may comprise a camera control unit (CCU) to control, at least in part, operation of the camera head 102.

The camera head 102 sends an image and/or a video stream captured by a camera to a processing unit 106. In some aspects, if the camera sends a video stream 111, the processing unit 106 may generate one or more images 112 from the video stream 111 at every frame. The steps discussed in more detail below may be applied to one or more (e.g. each) of the images 112 of the video stream 111. Additionally or alternatively, the camera may send images 112 themselves to the processing unit 106. In some aspects, an image 112 may comprise one or more subregions, where a subregion may include one or more pixels or groups of pixels. For example, a subregion may include a group of pixels arranged in a cluster (e.g., 1024 pixels arranged in a 32×32 grid, or 100 pixels arranged in a 10×10 grid, etc.). The processing unit 106 may receive image data (e.g., values representing light intensities for red, green, blue (RGB)) representing the image 112.

The camera head 102 may comprise a keypad including one or more buttons that allows the user to control one or more functions of the medical imaging system 100. The keypad may allow a user (e.g., surgeon, medical operator, nurse, etc.) to manually control various functions of the medical imaging system 100, including switching from one imaging mode to another.

The processing unit 106 may comprise memory that stores one or more reference styles 116. In some aspects, a reference style 116 may be stored as one or more layers in a neural network. A layer may encode some style information about the reference style 116. The user may select a reference style 116 at any time (e.g., before, during, or after surgery). The processing unit 106 may comprise a processor that applies the reference style 116 to the image(s) 112. For example, a model 114 (e.g., a machine-learning (ML) model, an artificial intelligence (AI) model, etc.) may convert the style of the image 112 in accordance with the selected reference style 116 to generate (e.g., create, modify, etc.) a modified image 118. In some aspects, the model 114 may convert the style of the image 112 in real time (intra-operatively). In some aspects, the model 114 may convert the style of the image 112 that is part of a recorded video (post-operatively). The processing unit 106 may generate and output image data representing a modified video stream 119 from the plurality of modified images 118 for display by the display 104.

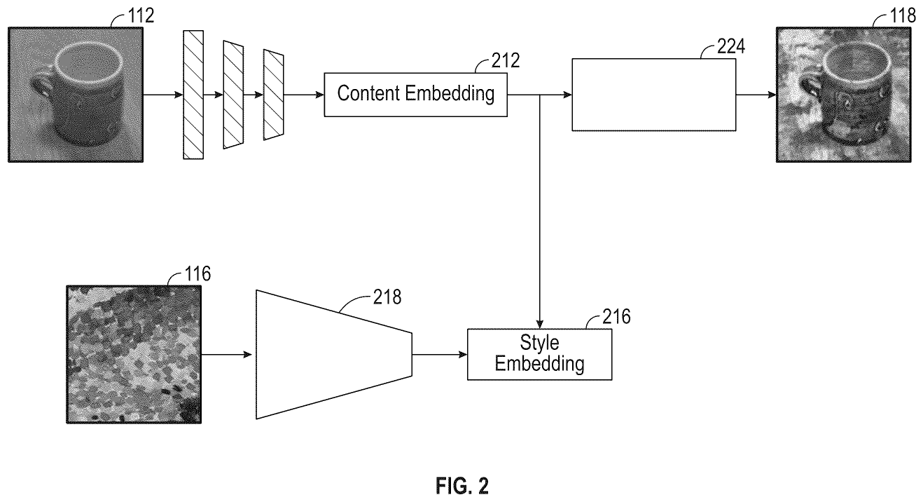

FIG. 2 illustrates an example high-level training workflow for a model 114 that converts the style of the image 112 in accordance with a selected reference style 116, according to some aspects. In some aspects, the model 114 may receive the image 112 and the selected reference style 116 as inputs. The model 114 may generate the modified image 118 as an output. In some aspects, the model 114 may be based on a neural network model (e.g., a single dimension neural network, a multidimension neural network, a Generative Adversarial Network (GAN) model, etc.). The model 114 may use an image 112 to determine (e.g., extract) the content information (content embedding 212) from the image 112. The model 114 may use the reference style 116 to determine the style information (style embedding 216) using an encoder model 218. The model 114 comprises a generator 224 that, during inference generates the modified image 118 based on the content embedding 212 and the style embedding 216. During inference, the model converts an image of any source domain (e.g., image 112) into the style or appearance of the reference domain image (e.g., reference style 116). The modified image 118 comprises the contents from the input image 112 and the style of the reference style 116.

### Example Fixed Reference Style Workflow

Examples of the disclosure comprise different types of reference styles 116. One example type of reference style is a fixed reference style, which may comprise a style that is pre-determined prior to the camera capturing the video stream 111 (or images) and/or the processing unit 106 generating the modified image 118. The fixed reference style 116 may be pre-determined and stored in memory prior to the procedure, and then may be retrieved from memory during the procedure.

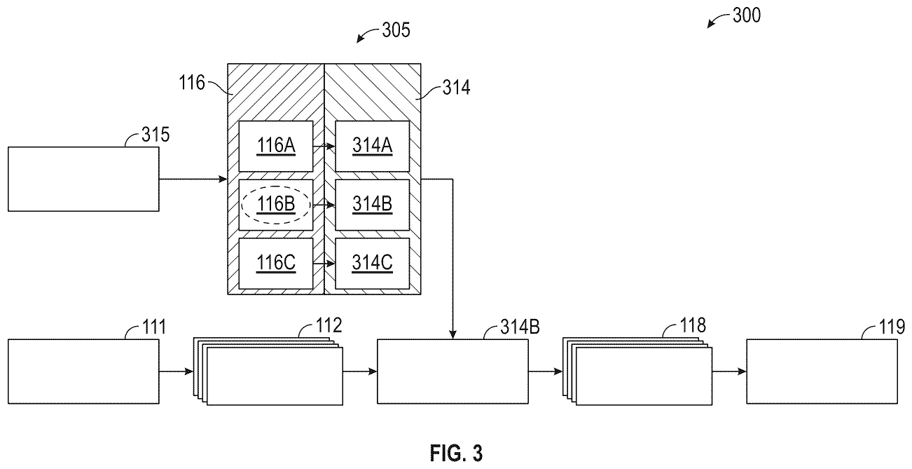

FIG. 3 illustrates an example workflow for a fixed reference style 116, according to some aspects. The workflow 300 comprises the processing unit 106 receiving a user's selection 315 and a video stream 111. The processing unit 106 may have memory 305 that stores one or more fixed reference styles 116 including fixed reference style 116A, fixed reference style 116B, and fixed reference style 116C. The processing unit 106 may select a fixed reference style 116B based on the user's selection 315. The user may be a surgeon, medical operator, nurse, etc. In some aspects, the user's selection 315 may be a style. Additionally or alternatively, the user may select from among a list of fixed reference styles 116 (e.g., presented to the user) or the processing unit 106 may select the fixed reference style 116 associated with the user's profile. In some aspects, the processing unit 106 may select a fixed reference style 116B that corresponds the most to the user's selection 315. The memory 305 may also store one or more models 314 including model 314A, model 314B, and model 314C. The plurality of models 314 may be pre-trained (trained before being stored in memory 305). The processing unit 106 may select a model 314 based on the user's selection 315 and/or the selected fixed reference style 116B. In some aspects, the selected model 314B may be the model that corresponds to the selected fixed reference style 116B.

The system may extract one or more images 112 from the video stream 111, and provide the plurality of images 112 to the selected model 314B. The selected model 314B may generate one or more modified images 118. In some aspects, the selected model 314B may determine style information to generate a style embedding 216. The style may be determined by using dimensional vector that represents style information of the one or more images 112 or a video stream 111. The style information may include, but is not limited to, gamma, contrast, hue, saturation, brightness, color correction, etc. The selected model 314B may determine content information and generate a content embedding 212 from the image 112. A generator 224 generates the modified images 118 during inference. In some aspects, generating the modified images comprises applying white balancing. The modified images 118 may be style-normalized images, for example. The system may then generate a modified video stream 119 using the plurality of modified images 118.

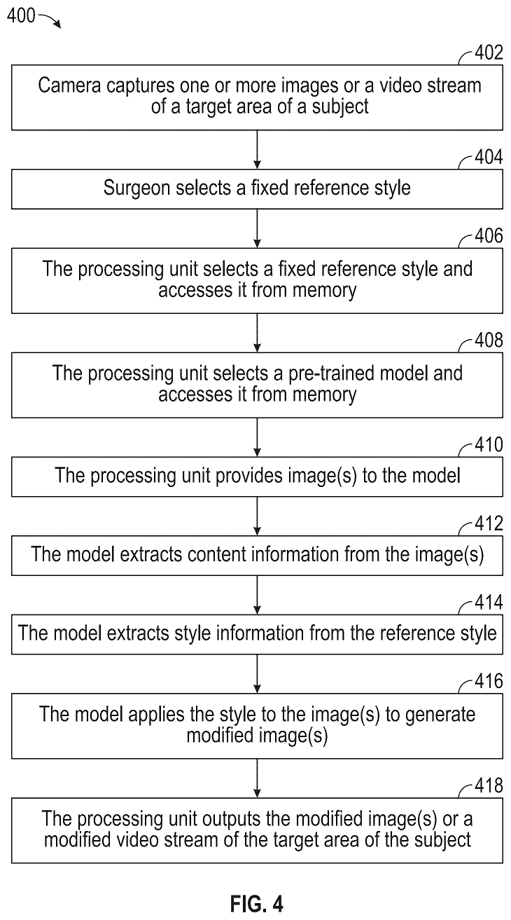

FIG. 4 illustrates an exemplary method 400 for generating a modified image 118 using a fixed reference style 116, according to some examples. Process 400 is performed, for example, using one or more electronic devices implementing a software platform. In some examples, process 400 is performed using only a computing device or only multiple computing devices. In process 400, some steps are, optionally, combined, the order of some steps is, optionally, changed, and some steps are, optionally, omitted. In some examples, additional steps may be performed in combination with the process 400. Accordingly, the operations as illustrated (and described in greater detail below) are exemplary by nature and, as such, should not be viewed as limiting.

At step 402, a camera captures an image 112 or video stream 111 of a target area of a subject. The camera may capture a still image or a video stream. The camera head 102 or the processing unit 106 may generate one or more images 112 from the video stream 111 at every frame.

An exemplary system (e.g., one or more computing devices) receives the image or video stream 111 of the target area of the subject. In some examples, the medical image is a white light image or a florescence image (e.g., a near-infrared or “NIR” image) of the target area of the subject. In some examples, the image 112 comprises one or more anatomical structures at the target area of the subject. The target area may include tissue of the subject, such as any biological tissue (e.g., breast tissue, a colon tissue, etc.).

At step 404, the user provides a selection 315 of a fixed reference style 116. At step 406, the processing unit 106 selects a fixed reference style 116 stored in memory. In some aspects, the fixed reference style(s) 116 selected and accessed from memory 305 is based on the user's selection 315 at any time (e.g., before, during, or after surgery). The user may select a reference style 116 using a keypad on the camera head 102, for example.

At step 408, the processing unit 106 selects a model 314 from memory based on the user's selection 315 and/or the selected fixed reference style 116. The selected model 314 may be a pre-trained model.

At step 410, the processing unit 106 provides one or more images 112 to a model 114. The processing unit 106 may extract the one or more images 112 from a video stream 111 captured by the camera.

At step 412, the model 114 extracts the content information from the image(s) 112 to determine a content embedding 212, and at step 414, the model extracts the style information from the reference style 116 to determine a style embedding 216. At step 416, the model 114 applies the reference style 116 to the image(s) 112, using a generator 224 (of the model 114) that uses inference to generate the modified image 118 based on the content embedding 212 and the style embedding 216. The inference converts the image 112 into the style of the reference style 116. The modified image 118 comprises the contents from the input image 112 and the style of the reference style 116.

At step 418, the processing unit 106 outputs the modified image(s) 118 or modified video stream 119 to the display 104 to be viewed, e.g., in real time.

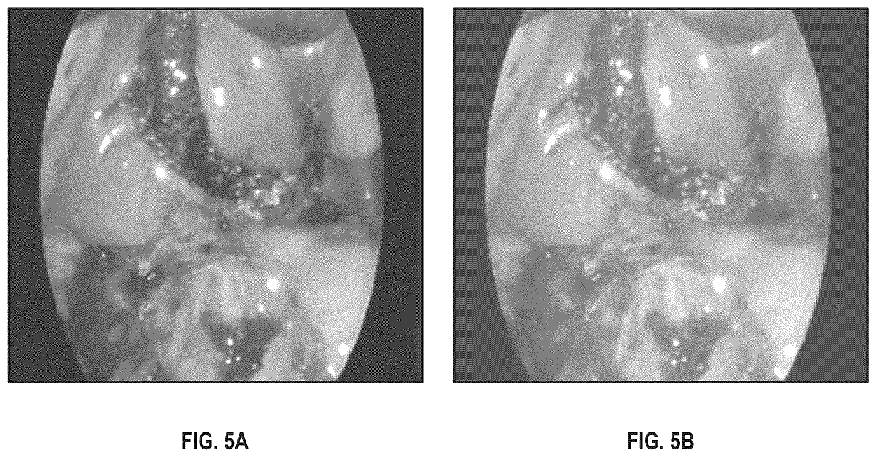

FIG. 5A illustrates an example image 112, and FIG. 5B illustrates an example modified image 118, according to some aspects. As shown in the figures, the selected model 314 may convert the style of the image 112 in real time so that the modified image 118 has a reduced amount of redness. In some aspects, the contents (e.g., layout, shape, and size of objects) of the image 112 may not be affected.

### Example Matched Reference Style Workflow

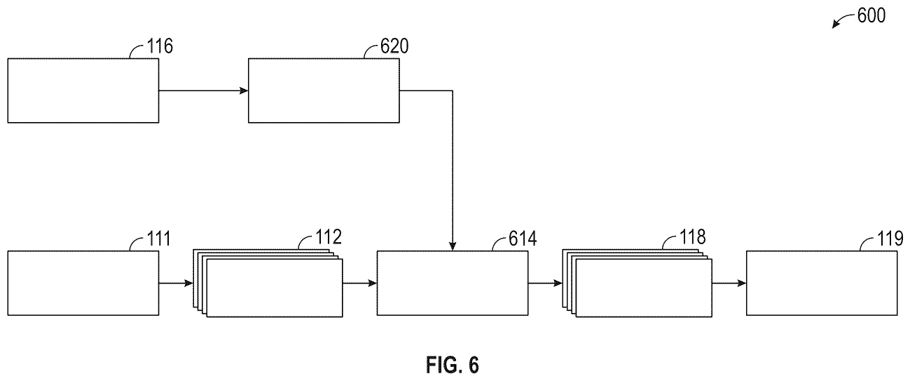

Another example type of reference style is a matched reference style 116 where the model 114 determines the type of style by extracting the style from one or more reference styles 116, or matches the style of one or more images to the style of the matched reference style 116. FIG. 6 illustrates an example workflow for a matched reference style, according to some aspects. The workflow 600 comprises the processing unit 106 receiving a user's input (preferred reference style 116) and a video stream 111. A model 114 may be trained in real time using trainer 620 and the user's preferred reference style 116. For example, the model 114 may be trained to determine (e.g., extract, retrieve, etc.) style information from the user's preferred reference style 116 and/or generate a match to the user's preferred reference style 116. The model 114 may be trained in an adaptive manner, referred to as an adaptive model 614. In such instances, the system does not use a fixed reference style that has been pre-determined and stored in memory, or a pre-trained model that has been stored in memory.

For example, content in a reference image (received from the user as input, or as part of the user's preferred reference style 116) may be determined, and then applied to the style of an image 112. In some aspects, one or more styles may be combined to form the user's preferred reference style 116. In some examples, the model 114 may trained to determine the type of style in the user's preferred reference style 116 during the procedure (while the camera is capturing the video stream 111 or images 112). In some aspects, the user's preferred reference style 116 may be modified (e.g., the user may modify an existing reference style 116 and/or store the modified reference style 116 for future use).

In some aspects, the model 614 may be trained to update the style information (e.g., data indicative of gamma, contrast, hue, saturation, brightness, color correction, histogram, etc., or a combination thereof) of the image 112 to match the style information of the reference style 116. In some aspects, converting the image 112 may comprise standardizing one or more images 112 captured through a device (e.g., camera head 102, display 104, etc.) to output one or more modified images 118 having a consistent style or appearance. For example, the model 614 may apply a neural style transfer technique. The image 112 may comprise content (e.g., objects in an image) and style (e.g., the appearance of an image). The model 614 may change the style of the image 112 to the reference style 116. In some aspects, the model 114 may retain the content of the image 112. The reference style 116 may be applied to one or more images 112, thereby making the image(s) 112 appear consistent with respect to each other or with respect to a reference image. The reference style 116 may be a preferred style of a user, where different users may have different preferred reference styles 116.

The system may determine one or more images 112 from the video stream 111, and provide the plurality of images 112 to the adaptive model 614. The adaptive model 614 may generate one or more modified images 118. The modified images 118 may be style-normalized images, for example. The system may then generate a modified video stream 119 using the plurality of modified images 118.

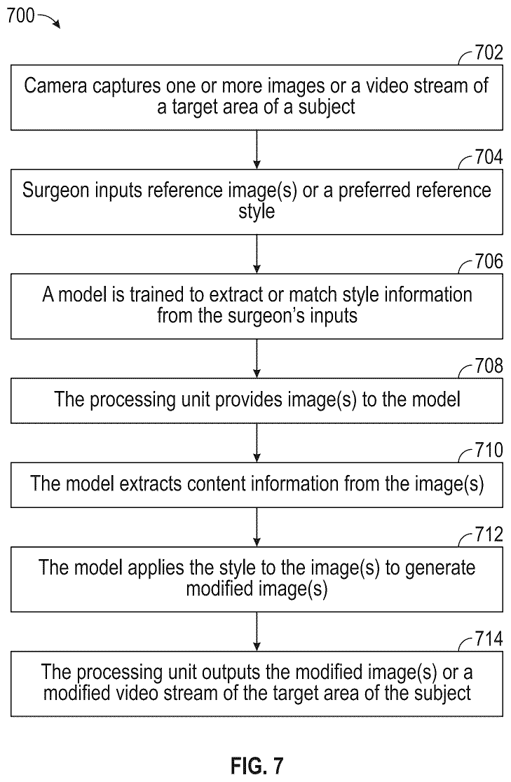

FIG. 7 illustrates an exemplary method 700 for generating a modified image 118 using a matched reference style 116, according to some examples. At step 702, a camera captures one or more images 112 or a video stream 111 of a target area of a subject. The camera may capture a still image or a video stream. In some aspects, the camera or the processing unit 106 may capture a video stream 111 and generate one or more images 112 from the video stream 111 at every frame.

An exemplary system (e.g., one or more computing devices) receives the image(s) 112 or video stream 111 of the target area of the subject. In some examples, the medical image is a white light image or a florescence image (e.g., a near-infrared or “NIR” image) of the target area of the subject. In some examples, an image 112 comprises one or more anatomical structures at the target area of the subject. The target area may include tissue of the subject, such as any biological tissue (e.g., breast tissue, a colon tissue, etc.).

At step 704, the user provides one or more reference images or a preferred reference style 116. At step 706, a model 614 is trained to extract or match style information from the user's reference images or preferred reference style 116. The trained model 614 may generate a style embedding using the extracted or matched style information. In some aspects, the trained model may be an adaptive model that is trained in an adaptive manner.

At step 708, the processing unit 106 provides one or more images 112 to the trained model 614. At step 710, the trained model 614 extracts content from the image(s) 112 to determine a content embedding 212. At step 712, the trained model 614 generates modified image(s) 118 based on the content embedding 212 (comprising content information) and style embedding 216 (comprising style information). In some aspects, generating the modified image(s) 118 comprises applying the style information to the image(s) 112. At step 714, the processing unit 106 outputs the modified image(s) 118 or modified video stream 119 (comprising the modified images 118) to be viewed on the display 104.

### Example Selective Style Application

In some aspects, the model 114 may receive other inputs related to style that are not reflected in a reference style 116. For example, a user may provide an input indicating that the user would like blood to be suppressed in the modified image 118. In some aspects, the models 114/314/614 may perform object recognition (e.g., to detect a user's tool in the image) and selectively omit applying the reference style 116, or may selectively apply a different reference style 116 to non-anatomical structures. For example, the models 114/314/614 may detect a tool as a non-anatomical structure located in an image 112 and retain the original style of the tool and/or make it appear transparent, while applying the reference style 116 to the remainder of the image 112.

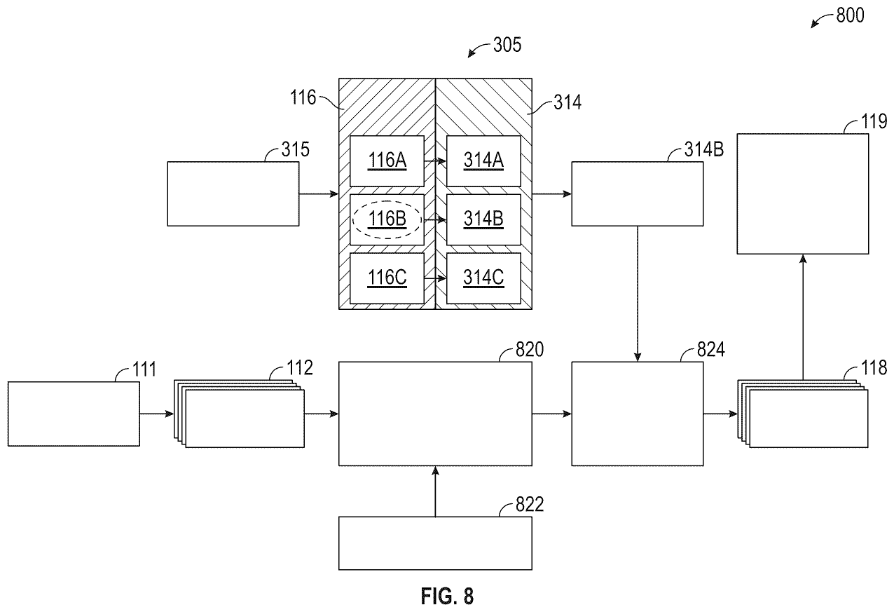

FIG. 8 illustrates an exemplary workflow for selectively applying a reference style to an object in an image, according to some aspects. Selectively applying a reference style comprises applying the reference style to some areas of the image (e.g., an object of interest), and not applying the reference style to other areas of the image. The workflow 800 comprises the processing unit 106 receiving a user's selection 315 and a video stream 111. The processing unit 106 selects a fixed reference style 116B based on the user's selection 315. The processing unit 106 may also select a model 314B based on the user's selection 315 and/or selected fixed reference style 116B.

The system may extract one or more images 112 from the video stream 111, and provide the plurality of images 112 to a segmentation model 820. The user may identify an object of interest 822 (e.g., anatomy) which the user wishes to selectively apply the style to. The segmentation model 820 receives the plurality of images 112 and the object of interest 822, and masks areas outside of the object of interest 822 to generate masked images. In some aspects, the segmentation model 820 may be configured to identify the object of interest 822 in the plurality of images 112.

The selected model 314B may determine style information to generate a style embedding 216. The selected model 314B may also determine content information from the masked images to generate a content embedding 212 from the image(s) 112. The user's preferred style is applied to the masked images 824 comprising the object of interest 822. The system generates the modified images 118. In some aspects, the modified images 118 comprise the object of interest 822 to which the style has been applied and areas outside of the object of interest to which a style has not been applied. The system may then generate a modified video stream 119 using the plurality of modified images 118.

### Example Inputs and Aspects of the Workflow

In some aspects, a reference style 116 may be used with different medical imaging systems 100. For example, if an old medical imaging system 100 is replaced with a new medical imaging system 100, a reference style 116 that was previously used with the old medical imaging system 100 may be used with the new medical imaging system 100. Similarly, if a user uses multiple medical imaging systems 100, the user's preferred reference style 116 may be used with some or all of the medical imaging systems 100, allowing the user to maintain an image/video style that the user is accustomed to.

Additionally or alternatively, the processing unit 106 may be capable of dynamically changing the reference styles 116. For example, a target area (e.g., having anatomical structures) may experience an increased amount of bleeding during a procedure. The user may control the processing unit 106 to switch from a first reference style 116 to a second reference style 116 during the procedure. The first and second reference styles 116 may have one or more style information that differ. For example, the amount of redness shown in the image may be reduced when switching from the first reference style 116 to the second reference style 116, thereby allowing the user to more easily identify the anatomical structures (e.g., liver, gallbladder, etc.). A specific reference style 116 may allow the user to discriminate anatomic structures during bleeding events or other imaging complications. This ability to switch reference styles 116 in real time (e.g., during a procedure) may enable the user to continue surgery without interruption. Examples of the disclosure include switching reference styles 116 while viewing the modified image(s) 118 or video stream 119 after the procedure, for example, using recorded image(s) or a recorded video stream.

In some aspects, the model 114 may selectively apply a reference style 116. The reference style 116 may have different style information for different subregions. For example, the reference style 116 may have a first subregion having a first style parameter and a second subregion having a second style parameter. The first style parameter may be applied to a corresponding first subregion of the image 112, and the second style parameter may be applied to a corresponding second subregion of the image 112.

### Example Model

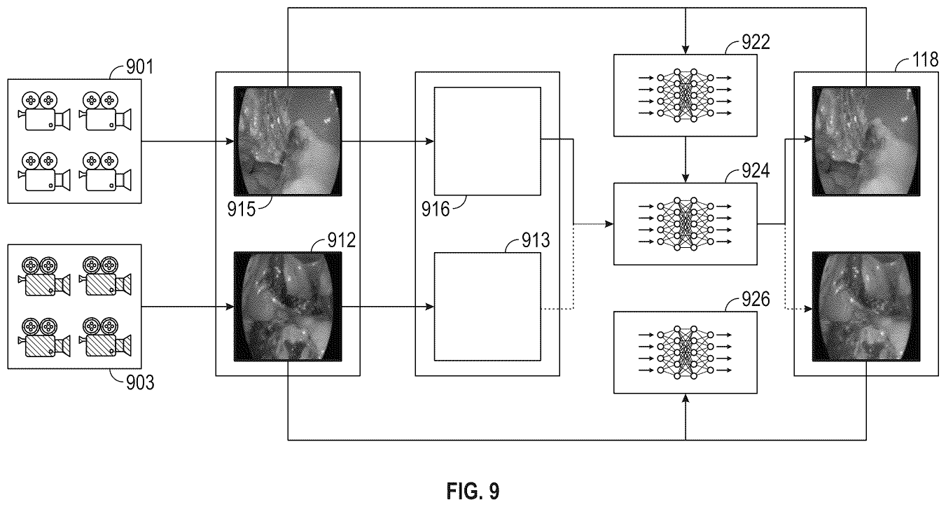

FIG. 9 illustrates an exemplary workflow 900 for training and testing a model, according to some examples. The model may comprise a single dimension neural network, a multidimension neural network, a Generative Adversarial Network (GAN) model, or a combination thereof. The system (e.g., one or more electronic devices) receives video streams 901 and 903 comprising preferred styled information and/or varied styles. The processing unit 106 may extract one or more images 915 or 912 from the video streams 901 and 903, respectively, at every frame.

As discussed above, the model 114/314/614 may be trained to convert input images to generate output images having a certain style. The model 114/314/614 can be trained using an algorithm that performs optimization based on hyperparameters and a set of (learned) parameters for minimizing a loss function. The optimization process may involve iteratively altering the style of the image using the parameters. The set of parameters may include, but is not limited to, one or more weights, coefficients, offsets, thresholds, an encoder, a decoder, or a combination thereof. In some aspects, the model 114/314/614 may be trained using a predefined optimization algorithm.

The model 114/314/614 may be trained using unlabeled images. In some aspects, the trained model 114/314/614 may be tested with a combination of one or more labeled correct test images and one or more labeled incorrect test images, involving an adversarial training process and scoring based on a deviation from a correct image. Collecting, labeling, and storing a large volume of training images can lead to inefficient usage of computer memory and processing power. By using unlabeled correct images to train the model, the techniques can lead to better usage and management of computer memory and more efficient usage of computer processing power, thus improving the functioning of a computer system. Also described herein are exemplary devices, apparatuses, systems, methods, and non-transitory storage media for using unsupervised learning, supervised learning techniques, or a combination thereof, to process medical images including visible light and fluorescence images. In some examples, an unsupervised model, which generally consists of an encoder and a decoder, is trained using unlabeled images. For example, the unlabeled training images can include image frames from intraoperative videos (e.g., videos of surgical procedures). Different image frames can be sampled from different time points in a video, and they are not labelled with any additional information. The encoder is trained to receive an input image and transform the input image into a latent representation, which represents the content of the image. Once the encoder extracts the latent representation, the decoder receives the latent representation to perform a downstream task (e.g., generate a modified image) that can be fine-tuned using training images that are labelled in accordance with the downstream task. The labeled training dataset can include fewer images than the unlabeled training dataset, thus reducing the need to label a large number of medical images. A first loss can be calculated based on a difference between the generated image and the training image. The generated image and real image may be provided to a trained discriminator to obtain a second loss, and the encoder may be updated based on the first loss and the second loss. In some aspects, the images used to train the model 114/314/614 may be different than the modified images 118 that the model 114/314/614 generates during a procedure.

The model 114/314/614 may be trained such that it does not alter the content of the input image when generating the output image. In some aspects, the images 915 and 912 during training may comprise an image having one or more subregions, where a subregion may include one or more pixels or groups of pixels. For example, a subregion may include a group of pixels arranged in a cluster (e.g., 1024 pixels arranged in a 32×32 grid, or 100 pixels arranged in a 10×10 grid, etc.).

In some examples, the model 114/314/614 is trained to analyze an image of a particular modality. The modality may correspond to a specific image type (e.g., fluorescence images, white light images), a specific tissue (e.g., images of breast tissue, images of colon tissue), a specific procedure (e.g., images associated with a plastic surgery), a specific patient type, a specific potential disease, a specific user, etc. In some aspects, the images in the training set may comprise only images have a correct style (correct images).

The model 114/314/614 is trained using the plurality of unlabeled training images. As discussed above, the training images comprise one or more unlabeled training images associated with a correct style and no images associated with an incorrect style. In some examples, the processing unit 106 may preprocess the images 915 and 912 to generate preprocessed images 916 and 913. For example, the images 915 and 912 may be cropped, rotated, segmented, aligned, etc.

The model 114/314/614 comprises a generator 924, a content discriminator 922, and a style discriminator 926. The generator 924 is configured to receive a pre-processed image and generate an output image. The content discriminator 922 is configured to ensure consistency of the content of the images. The style discriminator 926 is configured to ensure consistency of the style of the images. In some aspects, the model 114/314/614 may comprise an encoder configured to receive an input image and output a latent vector and a decoder to generate a modified image. In some examples, the model 114/314/614 is trained by training the generator 924 and the discriminators 922 and 926, and then training the encoder while the generator 924 and the discriminators 922 and 926 remain fixed. The steps may involve unlabeled training images associated only with correct styles. The generator 924 may output the modified images 118, which may then be used to generate a modified video stream 119.

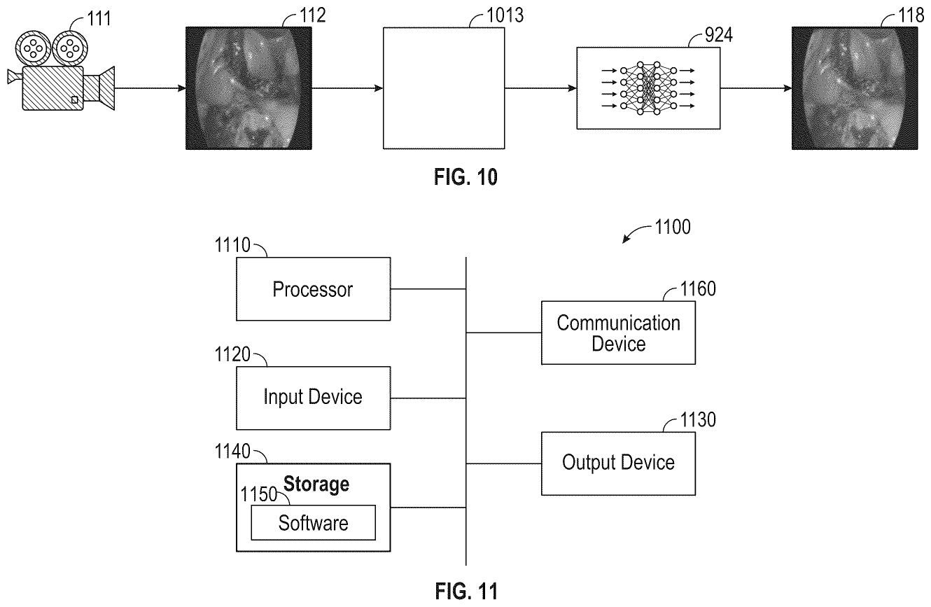

FIG. 10 illustrates an exemplary workflow 1000 for model inference, according to some examples. The system (e.g., one or more electronic devices) receives a video stream 111 captured by a camera. The processing unit 106 extracts one or more images 112 from the video stream 111 at every frame. The plurality of images 112 are preprocessed to generate preprocessed images 1013. The preprocessed images 1013 are then provided to a trained generator 924, which then generates a style-normalized image 118.

FIG. 11 illustrates an example computing system, in accordance with some examples, that can be used for performing any of the methods described herein, including method 400 of FIG. 4, method 700 of FIG. 7, workflow 300 of FIG. 3, workflow 600 of FIG. 6, workflow 800 of FIG. 8, and/or can be used for any of the systems described herein, including the system 100 of FIG. 1. System 1100 can be a computer coupled to a network, which can be, for example, an operating room network or a hospital network. System 1100 can be a client computer or a server. As shown in FIG. 11, system 1100 can be any suitable type of controller (including a microcontroller) or processor (including a microprocessor) based system, such as an embedded control system, personal computer, workstation, server, or handheld computing device (portable electronic device) such as a phone or tablet. The system can include, for example, one or more processor 1110, input device 1120, output device 1130, storage 1140, or communication device 1160.

Input device 1120 can be any suitable device that provides input, such as a touch screen, keyboard or keypad, mouse, gesture recognition component of a virtual/augmented reality system, or voice-recognition device. Output device 1130 can be or include any suitable device that provides output, such as a touch screen, haptics device, virtual/augmented reality display, or speaker.

Storage 1140 can be any suitable device that provides storage, such as an electrical, magnetic, or optical memory including a RAM, cache, hard drive, removable storage disk, or other non-transitory computer readable medium. Communication device 1160 can include any suitable device capable of transmitting and receiving signals over a network, such as a network interface chip or device. The components of the computer can be coupled in any suitable manner, such as via a physical bus or wirelessly.

Software 1150, which can be stored in storage 1140 and executed by processor 1110, can include, for example, the programming that embodies the functionality of the present disclosure (e.g., as embodied in the devices as described above). For example, software 1150 can include one or more programs for performing one or more the steps of the methods disclosed herein.

Software 1150 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1140, that can contain or store programming for use by or in connection with an instruction execution system, apparatus, or device.

Software 1150 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

System 1100 may be coupled to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

System 1100 can implement any operating system suitable for operating on the network. Software 1150 can be written in any suitable programming language, such as C, C++, C#, Java, or Python. In various examples, application software embodying the functionality of the present disclosure can be deployed in different configurations, such as in a client/server arrangement or through a Web browser as a Web-based application or Web service, for example.

The foregoing description, for the purpose of explanation, has been described with reference to specific aspects. However, the illustrative discussions above are not intended to be exhaustive or to limit the invention to the precise forms disclosed. Many modifications and variations are possible in view of the above teachings. The aspects were chosen and described in order to best explain the principles of the techniques and their practical applications. Others skilled in the art are thereby enabled to best utilize the techniques and various aspects with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A computer-implemented method for modifying a style of one or more images of a target area of a subject, comprising:
receiving the one or more images of the target area of the subject;
determining a content of the one or more images of the target area of the subject;
receiving an input from a user;
determining a reference style based on the user input; and
generating one or more modified images of the target area of the subject using the determined content and the determined reference style.

2. The computer-implemented method of claim 1, wherein the receiving, the determining, and the generating steps are performed in real time or post-operatively.

3. The computer-implemented method of claim 1, wherein the determining the reference style comprises selecting the reference style from a plurality of reference styles stored in memory.

4. The computer-implemented method of claim 1, wherein the determining the reference style comprises generating a style embedding from one or more reference images, or matching a style of the one or more images to the reference style of one or more reference images.

5. The computer-implemented method of claim 1, further comprising:
selecting a model from a plurality of models stored in memory, wherein the model performs the determining and the generating steps.

6. The computer-implemented method of claim 1, further comprising:
training a model to perform the determining steps in real time, wherein the training the model is performed before the receiving step.

7. The computer-implemented method of claim 1, wherein the one or more modified images comprise a style-normalized image.

8. The computer-implemented method of claim 1, wherein the determining the reference style comprises using a dimensional vector that represents style information of the one or more images, the style information include one or more of: gamma, contrast, hue, saturation, brightness, color correction, or a combination thereof.

9. The computer-implemented method of claim 1, wherein the generating the one or more modified images comprises selectively applying the determined reference style to the one or more images.

10. The computer-implemented method of claim 1, further comprising:
identifying an object of interest in the one or more images; and
generating one or more masked images by masking areas in the one or more images outside of the identified object of the interest.

11. The computer-implemented method of claim 1, further comprising:
switching from a first reference style to a second reference style during a procedure.

12. The computer-implemented method of claim 1, further comprising:
selectively applying a first reference style to a first area of the one or more images; and
selectively applying a second reference style to a second area of the one or more images.

13. The computer-implemented method of claim 1, further comprising:
receiving a video stream of the target area of the subject, wherein the receiving the one or more images of the target area of the subject comprises extracting the one or more images from the video stream.

14. The computer-implemented method of claim 1, wherein the receiving the one or more images comprises pre-processing the one or more images.

15. The computer-implemented method of claim 1, wherein the content and the reference style are determined using one or more of: a single dimension neural network, a multidimension neural network, a generative adversarial network (GAN) model, or a combination thereof.

16. The computer-implemented method of claim 1, wherein the content and the reference style are determined using a model trained using one or more unlabeled training images.

17. The computer-implemented method of claim 1, wherein the content and the reference style are determined using a model tested using one or more test images having a correct style.

18. The computer-implemented method of claim 1, wherein the content and style and determined using a model tested using one or more test images having a correct style and one or more test images having an incorrect style.

19. A system for modifying a style of one or more images of a target area of a subject, the system comprising:
a camera configured to capture the one or more images or a video stream of the one or more images of the target area of the subject;
a processing unit configured to receive an input from a user, the processing unit comprising:
a model configured to:
determine a content of the one or more images of the target area of the subject;
determine a reference style based on the user input; and
generate one or more modified images of the target area of the subject using the determined content and the determined reference style; and
a display configured to display the one or more modified images or a modified video stream of the one or more modified images.
